(19) United States
(12) Patent Application Publication
(10) Pub. No.: US 2013/0227531 A1
(43) Pub. Date: Aug. 29, 2013

(54) Methods and Systems for Modifying A Compiler to Generate A Profile of A Source Code

(71) Applicant: Zynga Inc., San Francisco, CA (US)

(72) Inventors: Gopal Vijayaraghavan, Bangalore (IN); Abhishek G. Nanda, Bangalore (IN); Anandamoy Roychowdhary, Pune (IN)

(21) Appl. No.: 13/774,263

(22) Filed: Feb. 22, 2013

Related U.S. Application Data
(60) Provisional application No. 61/603,189, filed on Feb. 24, 2012.

(51) Int. Cl. G06F 11/36

(52) U.S. Cl. CPC G06F 11/3672
USPC 717/130

(57) ABSTRACT

Systems and methods for modifying a compiler to generate a profile of a source code are described. One of the methods includes receiving the source code. The source code excludes instrumentation and includes functions. The method also includes compiling the source code with the compiler to generate metrics that are associated with execution of the functions within the source code. The compiling operation includes applying function tracking commands that were inserted into a compiler. The commands are used for tracking beginnings and ends of the functions to be tested.

### CLAIM OF PRIORITY

This application claims the benefit of and priority to, under 35 U.S.C. 119§(e), to U.S. Provisional Patent Application No. 61/603,189, filed on Feb. 24, 2012, and titled “Methods and Systems for Modifying a Compiler to Generate a Profile of a Source Code”, which is hereby incorporated by reference in its entirety.

### FIELD OF THE INVENTION

The present invention relates to methods and systems for modifying a compiler to generate a profile of a source code.

### BACKGROUND

Software programming has gained popularity and is continuing to gain popularity. Specifically, software programming for games creates excitement both among players and software programmers. In software programming, a software programmer writes a computer program using a computer programming language.

Once the computer program is written, the computer program is compiled with a compiler. If the computer program compiles, there may not be an error in the computer program. On the other hand, if the computer program does not compile, there usually is an error in the computer program. Some compilers may not be as effective as is desired. Accordingly, effectiveness of the compiler can be improved.

It is within this context that various embodiments of the present invention arise.

### SUMMARY

Embodiments of the present invention provide methods and systems for generating test information from a source code.

In several embodiments, a modified compiler is provided. The modified compiler includes one or more function tracking commands. The function tracking commands track beginnings and ends of functions within a source code. When the source code is compiled with the modified compiler, one or more metrics are generated. For example, a number of times one or more functions of the source code is executed is generated. As another example, a number of processor cycles consumed by one or more functions of the source code is generated. The metrics provide useful information regarding whether a function of the source code consumes an unusual amount of hardware resources or hardware resource cycles compared to the remaining functions of the source code.

In one embodiment, a method for generating a profile of a source code is described. The method includes receiving the source code. The source code excludes instrumentation and includes functions. The method also includes compiling the source code with the compiler to generate metrics that are associated with execution of the functions within the source code. The compiling operation includes applying function tracking commands that were inserted into a compiler. The commands are used for tracking beginnings and ends of the functions to be tested.

In another embodiment, a method for generating a profile of a source code is described. The method includes receiving profile data including metrics. The metrics are associated with execution of functions within the source code. The source code excludes instrumentation and is compiled using a compiler to generate the metrics. The compiler includes function tracking commands, which are used to track beginnings and ends of the functions. The method further includes generating report data from the profile data, rendering a report based on the report data, and sending the report data via a computer network.

In yet another embodiment, a method for modifying a compiler to generate a profile of a source code is described. The method includes receiving the compiler and modifying the compiler to generate metrics that are associated with execution of functions within the source code. The operation of modifying includes inserting function tracking commands, which are used to track beginnings and ends of the functions. The source code excludes instrumentation. The method is performed by a processor.

Other aspects of the present invention will become apparent from the following detailed description, taken in conjunction with the accompanying drawings, illustrating by way of example the principles of various embodiments of the present invention.

### BRIEF DESCRIPTION OF THE DRAWINGS

Various embodiments of the present invention may best be understood by reference to the following description taken in conjunction with the accompanying drawings in which:

FIG. 1 is a block diagram of an architecture for modifying a compiler to generate a profile of a source code, in accordance with one embodiment of the present invention.

FIG. 2 is a flowchart of a method for generating a profile of the source code, in accordance with one embodiment of the present invention.

FIG. 3 is a flowchart of a method for sending report data via a network, in accordance with one embodiment of the present invention.

FIG. 4 is a flowchart of a method for modifying a compiler to generate a modified compiler, in accordance with one embodiment of the present invention.

FIG. 5A is a block diagram of a user device that uses the modified compiler to generate metrics associated with the source code, in accordance with one embodiment of the present invention.

FIG. 5B is a block diagram of a user device that uses the modified compiler to generate metrics associated with the source code, in accordance with another embodiment of the present invention.

FIG. 6 is a block diagram of a user device that is used to generate the modified compiler, in accordance with one embodiment of the present invention.

FIG. 7 is a diagram illustrating how the source code is treated by the modified compiler, in accordance with one embodiment of the present invention.

FIG. 8A is a diagram of a first portion of a report that is generated after applying the modified compiler to the source code, in accordance with one embodiment of the present invention.

FIG. 8B is a diagram of a second portion of the report of FIG. 8A, in accordance with one embodiment of the present invention.

FIG. 8C is a diagram of a third portion of the report of FIG. 8A, in accordance with one embodiment of the present invention.

FIG. 8D is a diagram of a fourth portion of the report of FIG. 8A, in accordance with one embodiment of the present invention.

### DETAILED DESCRIPTION

It should be noted that various embodiments of the present invention may be practiced without some or all of these specific details. In other instances, well known process operations have not been described in detail in order not to unnecessarily obscure various embodiments of the present invention.

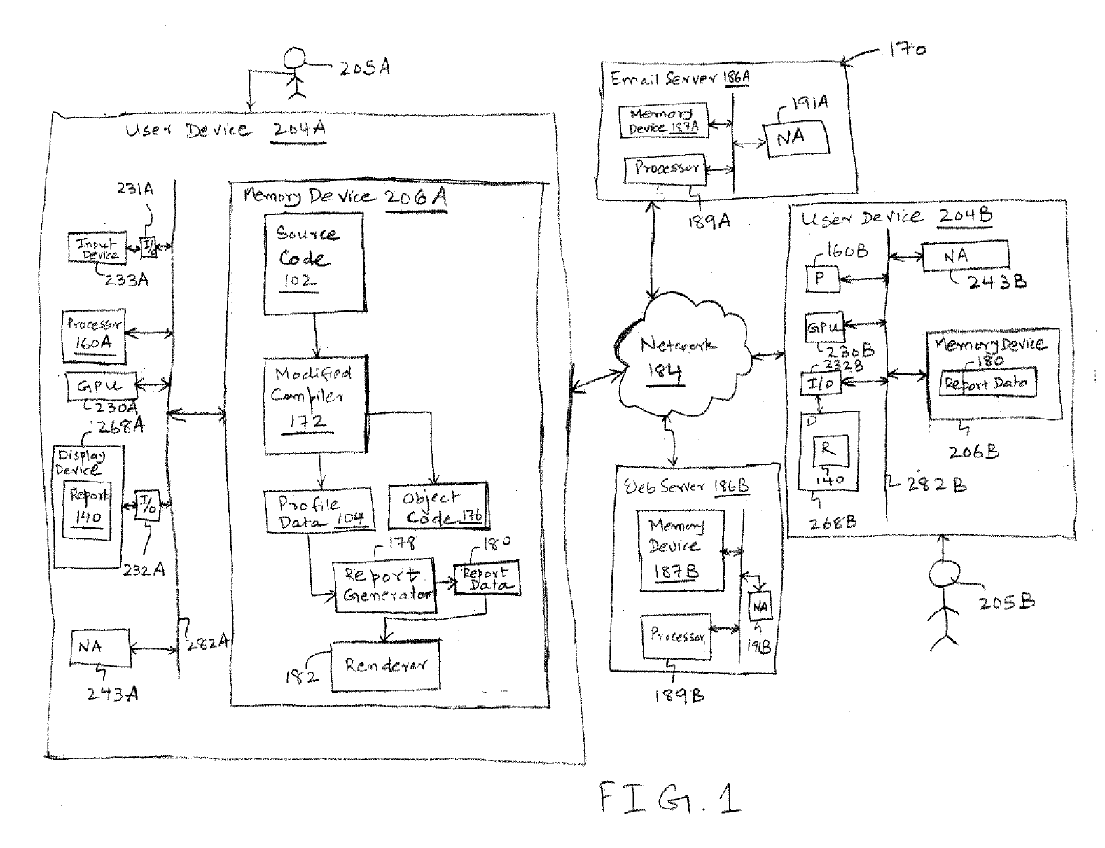

FIG. 1 is a block diagram of an embodiment of an architecture 170 for modifying a compiler to generate a profile of a source code 102. In some embodiments, the architecture 170 includes a computer network, such as the Internet or an Intranet. The source code 102 is stored within a memory device 206A of a user device 204A, which is operated by a user 205A. Examples of a user device include a tablet, a desktop computer, a cell phone, or a laptop computer. Examples of the source code 102 include a code for playing a game, a code for a word processing application, a code for a spreadsheet application, and a code for an email application. Other examples of the source code include an object-oriented code, such as an ActionScript code, C++, and Python. An object-oriented code includes a list of objects, such as a virtual person, a virtual house, a virtual tank, which interact with each other. The object-oriented code also includes a manner in which the objects are allowed to interact. The ActionScript code is designed to control two-dimensional vector animations, to create web-based games, or to create rich Internet applications with streaming media.

The source code 102 is compiled with a modified compiler 172, which is stored in the memory device 206A. The modified compiler 172 is written in a programming language, such as C, C++, or Objective-C. In other embodiments, the source code 102 and the modified code 172 are stored in different memory devices.

A processor 160A of the user device 204A accesses the source code 102 from the memory device 206A, accesses the modified compiler 172 from the memory device 206A and executes the modified compiler 172 to generate an object code 176 and profile data 104. A processor, as used herein, refers to an application specific integrated circuit (ASIC), a central processing unit (CPU), a programmable logic device (PLD), or a microprocessor.

The object code 176 is configured to be executed directly by a processor. The object code 176 is in a format that is readable by a processor. The source code 102 is in a format that can be understood by a programmer user, such as the user 205A, who is familiar with a programming language used in the source code 102. A programming language usually includes syntax, such as form, and further includes semantics, such as meaning. Examples of a programming language include C++, Java, Delphi, Pert, and Fortran, to name a few.

The source code 102 includes one or more functions. For example, a function of the source code 102 includes a movement, such as a walking or running movement of a virtual user. As another example, a function of the source code 102 includes building of a virtual house by a virtual user. As yet another example, a function of the source code 102 includes a shooting of a virtual gun by a virtual user. As another example, a function of the source code 102 includes a function of a virtual object within the source code 102. Examples of the virtual object include a virtual user, a virtual structure, a virtual machine, virtual rewards, and virtual life cycles. The virtual structure may be a virtual house or a virtual building. The virtual machine may be a virtual car, a virtual tank, a virtual bicycle, a virtual vehicle, a virtual gun, or a virtual weapon. In one embodiment, a function is a routine of the source code 102 that performs a specific task, such as walking, building, demolishing, firing a weapon, extending arms, and is relatively independent of the remaining portions of the source code 102.

In one embodiment, the source code 102 excludes instrumentation. For example the source code 102 excludes a portion that is executed to generate metrics, which are described below. The instrumentation does not modify any function of the source code 102. The instrumentation is used to generate metrics.

Examples of profile data 104 include an exclusive number of hardware resources used during execution of each function of the source code 102, an exclusive amount of time taken to execute each function of the source code 102, an exclusive number of times each function of the source code 102 is called by the same or a different function, and an exclusive number of hardware resource cycles consumed by execution of each function of the source code 102. Examples of the hardware resource cycles include processor cycles and memory cycles. Examples of the hardware resources include processors and memory elements. A memory element may be a memory cell or a memory device. A memory cell is a unit of a memory device. For example, a memory cell is a RAM cell or a transistor. Examples of a memory device include a memory stick, a memory card, a read-only memory (ROM) device, a random access memory (RAM) device, or a hard disk.

An exclusive number of times a calling function of the source code 102 is called includes a number of times associated with the calling function regardless of a number of functions called by the calling function. For example, if a calling function of the source code 102 includes a call to a function, the profile data 104 includes a number of times the calling function is executed without taking in account a number of times the called function is executed. The number of times of execution of the calling function is the exclusive number of times.

Moreover, if a function of the source code 102 calls a function, a number of hardware resource cycles consumed by the calling function without taking into account a number of hardware resource cycles consumed by the called function is an exclusive number of hardware resource cycles consumed by the calling function. Furthermore, if a function of the source code 102 calls a function, a number of hardware resources consumed by the calling function during execution of the calling function without considering a number of hardware resources consumed by the called function is an exclusive number of hardware resources consumed by the calling function. Additionally, if a function of the source code 102 calls a function, an amount of time taken to execute the calling function without considering an amount of time taken to execute the called function is an exclusive amount of time taken to execute the calling function.

Another example of profile data 104 includes a total number of times a calling function and a function that is called by the calling function are executed. The total number of times of execution is referred to herein as an inclusive number of times the calling function is executed. Also, as another example, the profile data 104 also includes a total number of hardware resource cycles consumed by a calling function and a function called by the calling function. The total number of hardware resource cycles is referred to herein as an inclusive number of processor cycles consumed by the calling function.

As another example, a total amount of time taken to execute a calling function and a function called by the calling function is an inclusive amount of time taken to execute the calling function. As another example, a total number of hardware resources consumed by a calling function and a function called by the calling function is an inclusive number of hardware resources consumed by the calling function during execution of the calling function.

A number, inclusive or exclusive, of times a function is called is another example of a metric of the function. Furthermore, an amount of time, inclusive or exclusive, consumed by execution of a function is an example of a metric of the function. Moreover, a number of hardware resources or hardware resource cycles used by a function during execution of the function is an example of a metric of the function.

A report generator 178 uses the profile data 104 to generate report data 180. For example, the profile data 104 is formatted to generate the report data 180. As another example, a line-by-line format of a name of each function of the source code 102 and metric of the function is generated. As another example, a hierarchical tree format is generated. In the hierarchical tree, a representation of a calling function is placed at a node and a representation, such as a name or an identification, of a function called by the calling function is placed at another node that has a lower place in the hierarchy. Besides the node that represents the calling function, a metric of the calling function is placed and besides the node that represents the called function, a metric of the called function is placed. The report generator 178 is executed by the processor 160A to generate the report data 180.

A graphical processing unit (GPU) 230A of the user device 204A executes a renderer 182 to display a report 140 based on the report data 180. The report 140 is displayed on a display device 268A, such as, a light emitting diode (LED) display device, a liquid crystal display (LCD) device, a cathode ray tube (CRT) display device, or a plasma display device, of the user device 204A. The display device 268A is coupled with a bus 282A via an input/output (I/O) interface 232A. Also, a network adapter 243A, the GPU 230A, the processor 160A, an I/O interface 231A, and memory device 206A are coupled with each other via the bus 282A. The I/O interface 231A is coupled with an input device 233A. Examples of an input device include a mouse, a keyboard, a stylus, and a touchscreen. The touchscreen may be a display screen of a display device.

The report data 180 is attached to an email sent from the network adapter 243A of the user device 204A via a network 184 to a user device 204B, which is operated by a user 205B. The network 184 is a computer network that includes one or more servers and communication equipment, such as routers, repeaters, bridges, switches, firewalls, and hubs. A network adapter is a network interface card (NIC) or a modem.

A processor 189A of an email server 186A provides an email service to the user devices 204. For example, the processor 189A temporarily stores, in a memory device 187A of the email server 186A, the email received from the user device 204A before sending the email to the user device 204B. The processor 189A, the memory device 187A, and a network adapter 191A of the email server 186A are coupled with each other via a bus. The memory device 187A includes a database of email accounts of users 205. Also, the network adapter 191A handles transfer of emails to and from user devices 204 and other email servers.

The user 205B accesses the email received via the network 184 and a network adapter 243B and opens the attachment to the email. When the attachment is opened, a GPU 230B of the user device 204B executes a renderer to generate the report 140. The GPU 230B is coupled with a processor 160B, a network adapter 243B, an I/O 232B, and a memory device 206B via a bus 282B.

It should be noted that in some embodiments, a modified compiler, a report generator, and a renderer are modules, which are computer programs.

In some embodiments, the report data 180 is uploaded by the user 205A via the input device 233A, the processor 160A, and the network adapter 243A to a memory device 187B of a web server 186B, which is coupled with a processor 189B and a network adapter 191B via a bus. The user 205A attaches a hyperlink to the report data 180 in an email and sends the email via the network 140 to the user device 204B. The user 205B selects the link in the email to access the report data 140 from the memory device 187B. When the user 205B accesses the report data 140, the GPU 230B executes a renderer to generate the report 140.

In various embodiments, the user device 204A excludes the source code 102 and the modified compiler 172. For example, the user device 204A receives the profile data 104 from another user device that compiles the source code 102 with the modified compiler 172. In these embodiments, the other user device has a memory device that is used to store the source code 102 and the modified compiler 172.

Although the source code 102, the modified compiler 172, the profile data 104, the object code 176, the report generator 178, the report data 180, and the renderer 182 are stored within the memory device 206A, in some embodiments, the source code 102, the modified compiler 172, the profile data 104, the object code 176, the report generator 178, the report data 180, and the renderer 182 are stored in separate memory devices. For example, the source code 102 is stored in the memory device 206A and the modified compiler 172 is stored in another memory device.

It should be noted that a server, as used herein, is a physical server. In other embodiments, a server includes a virtual machine.

In various embodiments, functions performed by a GPU of a user device are performed by a processor of the user device. For example, functions performed by GPU 230A are performed by the processor 160A.

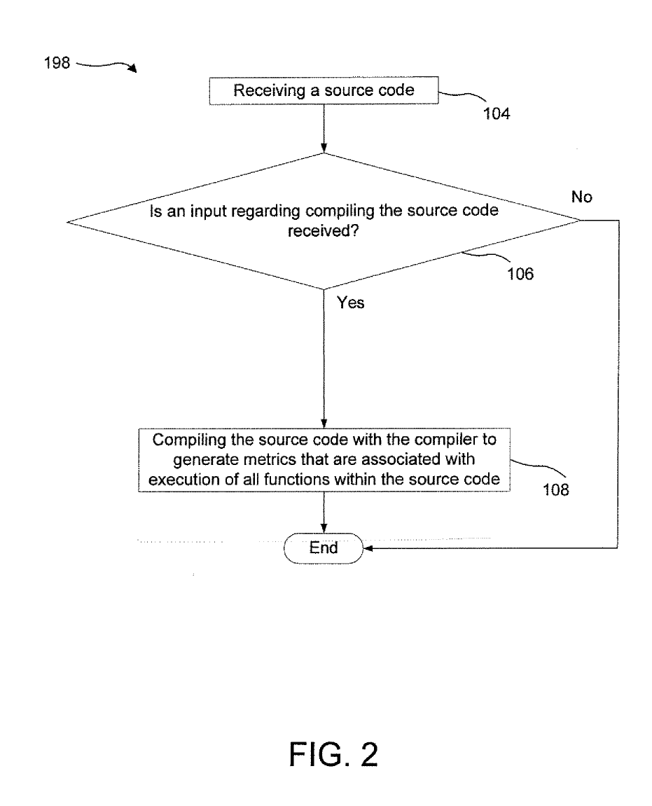

FIG. 2 is a flowchart of an embodiment of a method 198 for generating a profile of the source code 102 (FIG. 1). The method 198 is executed by one or more processors, such as processor 160A (FIG. 1). In operation 104, the source code 102 is accessed from the memory device 206A (FIG. 1). For example, the processor 160A reads the source code 204A that is stored within the memory device 206A (FIG. 1).

In operation 106, a determination is made whether an input regarding compiling the source code 102 is received from the user 205A (FIG. 1) via the input device 233A (FIG. 1). For example, the user 205A selects a button displayed on the display device 268A (FIG. 1) to provide an input to compile the source code 102. As another example, the user 205A selects an option from a drop down menu displayed on the display device 268A.

If it is determined that the input regarding compiling the source code 102 is not received, the method 198 ends. On the other hand, in response to determining that the input regarding compiling the source code 102 is received, in operation 108, the source code 102 is compiled with the modified compiler 172 to generate metrics that are associated with execution of all functions within the source code. For example, if the source code 102 includes 200 functions, the source code 102 is compiled with the modified compiler 172 to generate metrics for all the 200 functions. As another example, if the source code 102 includes 400 functions, the source code is compiled with the modified compiler 172 to generate metrics for all the 400 functions. As yet another example, if the source code 102 includes a function of walking and a function of building, the source code 102 is compiled to generate metrics that includes a number of processor cycles consumed to perform the function of walking and a number of processor cycles consumed to perform the function of building.

During the operation 108, function tracking commands that were inserted into an unmodified compiler are applied to the source code 102. The function tracking commands were inserted into the unmodified compiler to generate the modified compiler 172 (FIG. 1). In some embodiments, the function tracking commands were inserted by a processor of a user device to generate the modified compiler 172.

An example of a function tracking command includes a command to generate a metric for each function of the source code 102. Other examples of function tracking commands include one or more commands to calculate an inclusive or exclusive number of times of each function of the source code is called for execution and one or more commands to calculate an inclusive or exclusive number of hardware resource cycles consumed by a function. Yet another example of function tracking commands includes one or more commands to calculate an inclusive or exclusive amount of time of execution of a function. Another example of function tracking commands includes an inclusive or exclusive number of hardware resources that are used during execution of a function. In some embodiments, the function tracking commands are inserted to generate one or more metrics for all functions of the source code 102. The method 198 ends after operation 108.

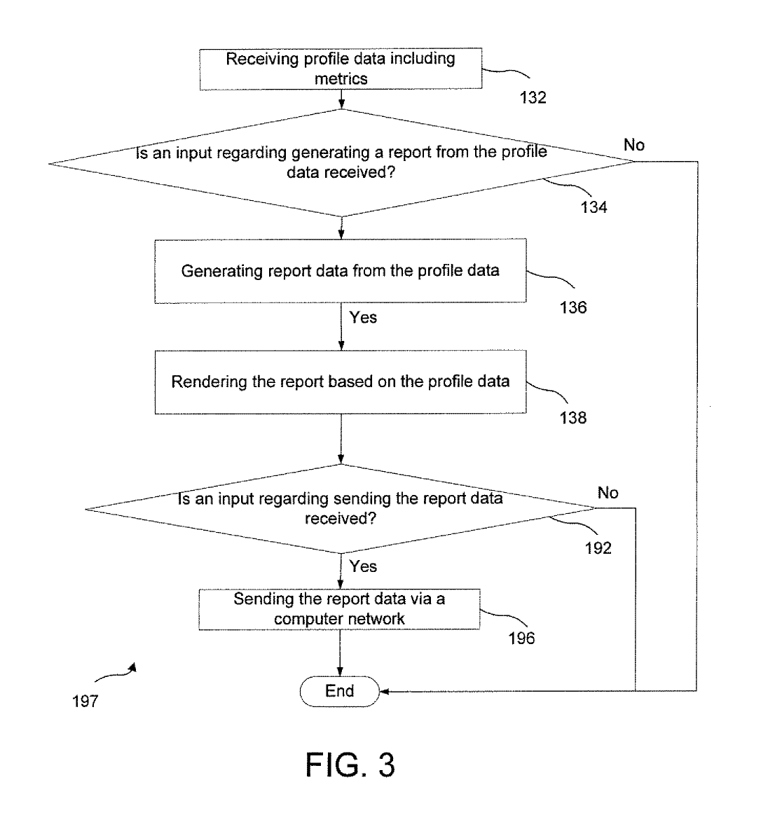

FIG. 3 is a flowchart of an embodiment of a method 197 for sending report data 180 via the network 184 (FIG. 1). The method 197 is executed by one or more processors, such as processor 160A (FIG. 1). In operation 132, the profile data 104 (FIG. 1) is received. For example, the profile data 104 is received by processor 160A via network adapter 243A and the network 184 from another user device (FIG. 1). As another example, the profile data 104 is accessed by processor 160A from memory device 206A (FIG. 1).

In operation 134, it is determined whether an input regarding generating the report 140 from the profile data 104 is received. As an example, the user 205A selects a button of the input device 233A to provide the input regarding generating the report 140 (FIG. 1). As another example, the user 205A selects an option within a drop-down menu displayed on the display device 268A to provide the input regarding generating the report 140.

If it is determined that the input regarding generating the report 140 is not received, the method 197 ends. On the other hand, if it is determined that the input regarding generating the report 140 is received, in operation 136, the report data 180 is generated from the profile data 104 (FIG. 1). Furthermore, in operation 138, the report 140 (FIG. 1) is rendered from the report data 180. For example, the display device 268A renders the report 140 on a display screen of the display device 268A.

In operation 192, it is determined whether an input regarding sending the report data 180 is received. For example, the processor 160A determines whether a “send” button that is displayed on the display device 268A is selected by the user 205A. The user 205A selects the “send” button via the input device 233A. When the “send” button is selected, an email to which report data 180 is attached is sent via the network 184 to the user device 204B (FIG. 1). As another example, when a “send” button on the display device 268A is selected by the user 205A via the input device 233A, an email to which a hyperlink is attached is sent via the network 184 to the user device 204B (FIG. 1). The hyperlink is a link to the report data 180 that is stored on the web server 186B (FIG. 1). The report data 180 is stored within the memory device 187B of the web server 186B when the user 204A uses the input device 233A to upload the report data 180 to the web server 186B (FIG. 1).

Upon determining that an input regarding sending the report data 180 is not received, the method 197 ends. On the other hand, upon determining that an input regarding sending the report data is received, in operation 196, the report data 180 is sent from the user device 204A via the network 184 to the user device 204B.

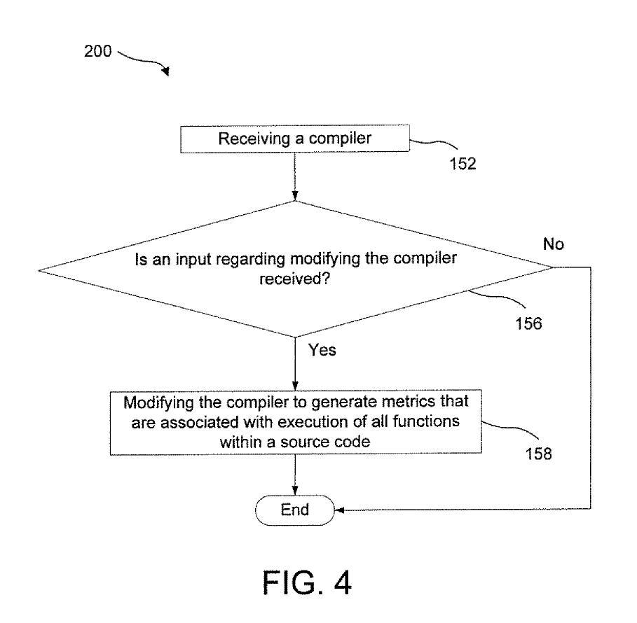

FIG. 4 is a flowchart of an embodiment of a method 200 for modifying a compiler to generate the modified compiler 172 (FIG. 1). The method 200 is executed by one or more processors, such as a processor 160C, described below. In operation 152, a compiler is received by a user device. In operation 156, a determination is made as to whether an input regarding modifying the compiler is received. For example, it is determined whether a user has made a selection on an input device of a user device to initiate a modification of the compiler. For example, a user selects a button displayed on a display device of a user device and upon receiving the selection, a processor of the user device determines to modify the compiler to generate the modified compiler 172. As another example, a user selects an option from a drop-down menu that is displayed on a display device of a user device and upon receiving the selection, a processor of the user device determines to modify the compiler to generate the modified compiler 172. Upon determining that the input regarding modifying the compiler is not received, the method 200 ends.

On the other hand, upon determining that the input regarding modifying the compiler is received, in operation 158, the compiler is modified to generate metrics that are associated with executed with all functions of the source code 102. For example, the compiler is modified with function tracking commands to generate the modified compiler 172 and the source code 102 is compiled with the modified compiler 172 to generate metrics associated with the execution of all functions of the source code 102. As another example, function tracking commands are inserted into the compiler to monitor beginnings and ends of each function of the source code 102. The method 200 ends after operation 158.

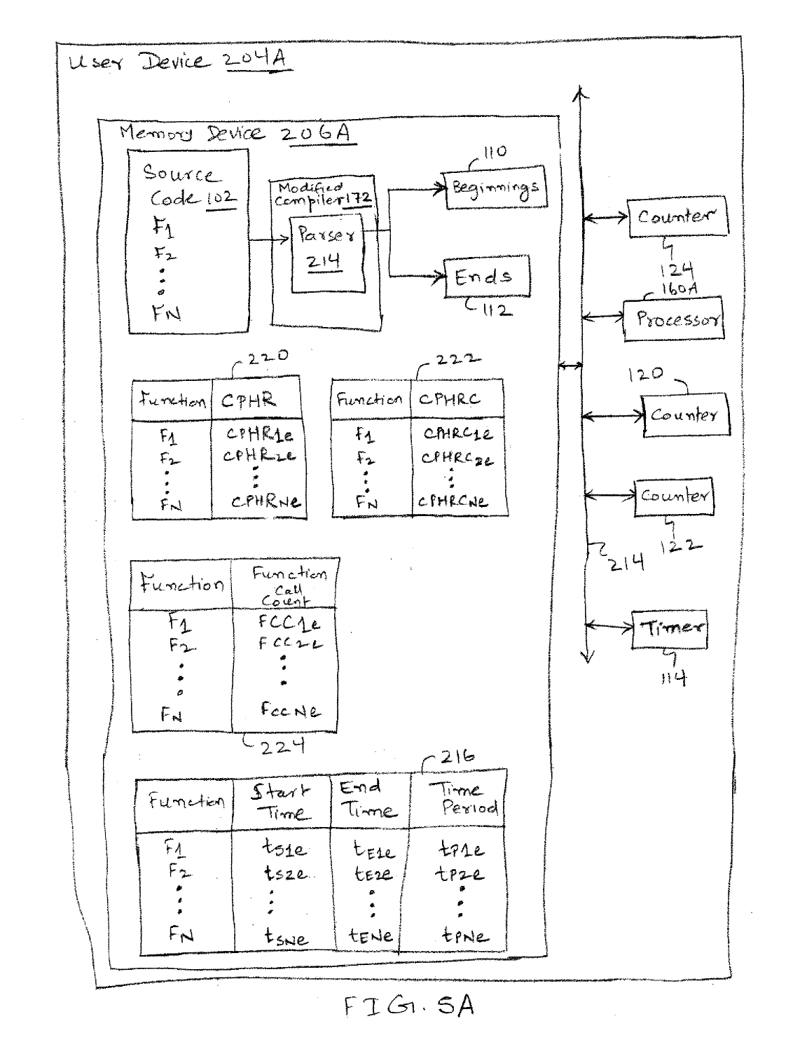

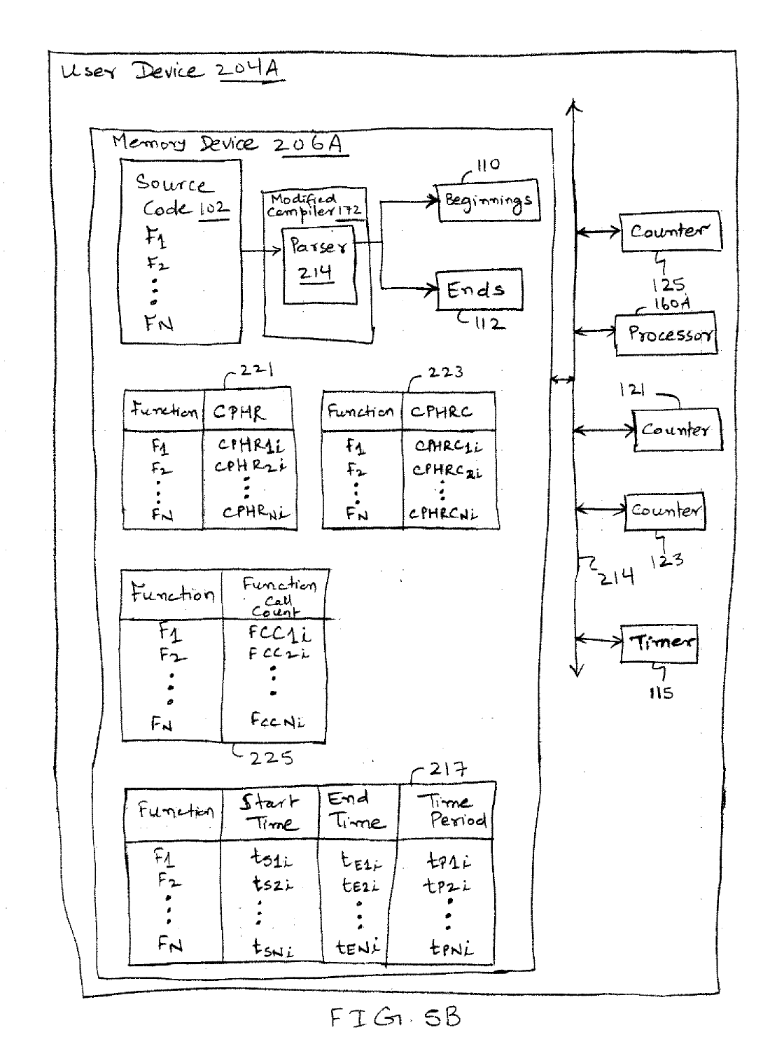

FIG. 5A is a block diagram of an embodiment of the user device 204A that uses the modified compiler 172 to generate metrics associated with the source code 102. The source code 102A includes one or more functions F₁ thru F_{N}, where N is an integer. When an input to compile the source code 102 is received from the user 205A via the input device 233A, the processor 160A executes the parser 214 within the modified compiler 172 to parse the source code 102. For example, the processor 160 executes the parser 214 to determine beginnings 110 and ends 112 of the functions F₁ thru F_{N}. In some embodiments, the function F₁ has a beginning 110₁ and an end 112₁, the function F₂ has a beginning 110₂ and an end 112₂, and so on until the function F_{N} has a beginning 110_{N} and an end 112_{N}.

In addition to lexical analysis, the parser 214 performs syntactic analysis to determine beginnings 110 and ends 112 of each function of the source code 102. The syntactic analysis is performed based on a programming language of the source code 102. For example, syntactic analysis for Python is different than syntactic analysis for C++. A syntactic analysis includes determining a sequence of characters or a combination of the sequence and spatial layout of symbols, which are textual or graphical. Examples of syntax of functions include a character sequence “main( )” that indicates a beginning of a main function, a character sequence “print( )” that indicates a print function and a character sequence “if( )” that indicates a conditional “if” function. As another example, in C++ programming language, a beginning bracket character “{” indicates a beginning of function and an ending bracket character “}” defines an ending of the function. In this example, when the character sequence “print( )” is followed by a beginning bracket character “{”, the parser 214 understands that the print function is beginning. Moreover, in this example, when the character sequence “print( )” is followed by only one ending bracket character “}”, the parser 214 understands that the print function is ending. Also, in this example, when the character sequence function “print( )” is followed by multiple ending brackets characters “}”, the parser 214 understands that there are more functions than just the print function ending. In such a case, the parser 214 understands the last ending bracket “}” as the end of the print function.

A timer 114 starts in response to determining that the beginnings 110 of the functions F₁ thru F_{N} are reached during compiling the source code 102 with the modified compiler 172. For example, the timer 114 starts at a start time t_{S1e} when the processor 160A determines that the beginning 110₁ of the function F₁ is reached for execution. When the processor 160A determines that the end 112₁ of the function F₁ is reached, the timer 114 stops at a time t_{E1e}.

If the function F₁ is calling function that calls another function, the timer 114 stops at a time t_{S1CS1e} when the called function is called. For example, the timer 114 stops at the time t_{S1CS1e} when a beginning of the called function is reached. The timer 114 stops until an end of the called function is reached. The timer 114 starts at a time t_{S1CE1e} when there is a return to the calling function F₁ and then stops at the time t_{E1e} when the function F₁ ends executing. A time period t_{P1e} between the times t_{S1e} and t_{E1e} is an exclusive amount of time for execution of the function F₁ by the processor 160A during compilation of the source code 102.

Similarly, the time periods t thru t_{PNe}, which are exclusive amount of times for execution of the remaining functions F₂ thru F_{N} are determined based on the remaining start times t_{S2e} thru t_{SNe} and the remaining end times t_{E2e} thru t_{ENe}. The processor creates a database 216 of the start times t_{S1e} thru t_{SNe}, the end times t_{E1e} atm t_{ENe}, and the time periods t_{P1e} thru t_{PNe} for the functions F₁ thru F_{N}.

A counter 120 increments its count when the function F₂ is called by the same function F₂ or another function F₁ or F₃ thru F_{N} during compilation of the source code 102 with the modified compiler 172. For example, when the function F₂ is called by the function F₁, the beginning 110₁ of the function F₂ is determined by the processor 160A, the function F₂ is executed, and the counter 120 increments its count. It should be noted that in some embodiments, all functions of the source code 102 except for the main function have a capability to call themselves. In these embodiments, a main function cannot call itself. When a function is called, the function is executed.

If the function F₂ is a calling function that includes a call to another function F₃, the counter 120 does not increment when the function F₃ is called to generate an exclusive number of times FCC₂ₑ the function F₂ is called. For example, when the processor 160A determines that the beginning 110₃ of the function F₃ is reached during execution of the function F₂, the counter 120 does not increment its count. In this example, the count FCC₂ᵢ is equal to one for calling the function F₂ regardless of the time the function F₃ is called by the function F₂. If after execution of the function F₃, the function F₂ continues execution, the counter 120 does not increment its count. The count FCC₂ₑ of a number of exclusive times the function F₂ is called is an exclusive count. Similarly, exclusive counts FCC₁ₑ and FCC₃ₑ thru FCC_{Ne} corresponding to functions F₁ and F₃ thru F_{N} are determined. The exclusive counts FCC₁ₑ thru FCC_{Ne} are stored in a database 224 of the memory device 204A.

A counter 122 counts a number of hardware resource cycles consumed by execution of each function F₁ thru F_{N} during compilation of the source code 102. For example, each time a processor cycle of processor 160A passes during execution of the function F₁, the counter 122 increments. As another example, when the processor 160A determines that the beginning 110₁ of the function F₁ is reached, the counter 122 starts counting a number of memory cycles of one or more memory elements used during execution of the function F₁.

If the function F₁ is a calling function that calls another function F₂, the counter 122 is not incremented during execution of the function F₂ to generate an exclusive number CPHRC₁ₑ of hardware resource cycles. For example, if during execution of the function F₁, the processor 160A determines that the beginning 110₂ of the function F₂ is reached, the counter 122 stops counting. After the execution of the function F₂, the count of counter 122 continues its count from where it left off before execution of the function F₂ if the function F₁ includes more computer code that consumes hardware resource cycles. For example, when the processor 160A determines that the end 112₂ of the function F₂ is reached, the counter 122 continues its counts from where it left off before the beginning 110₂. When an end of the function F₁ is reached after execution of the function F₂, the counter 122 stops counting a number of hardware resource cycles. For example, when the processor 160A determines that the end 112₁ is reached after execution of the function F₂, the counter 122 stops its count. Accordingly, the exclusive number CPHRC₁ₑ of hardware resource cycles is counted by counter 122 during execution of the function F₁.

Similarly, an exclusive number CPHRC₂, thru CPHRC_{Ne} of hardware resource cycles are generated. The processor 160A stores the exclusive numbers CPHRC_{1e thru CPHRC}_{Ne} of hardware resource cycles within a database 222 of the memory device 204A.

Another counter 124 counts a number of hardware resources consumed by execution of each function F₁ thru F_{N} during compilation of the source code 102 to generate exclusive numbers CPHR₁ₑ thru CPHR_{Ne} of hardware resources used during compilation of the functions F₁ thru F_{N}. For example, each time a memory element, such as a memory cell or a memory device, is accessed, for an operation, such as a read or a write, during execution of the function F₁, the counter 124 increments. As another example, when the processor 160A determines that the beginning 110₁ of the function F₁ is reached and each time a memory element is used during execution of the function F₁, the counter 124 increments.

If during execution of the function F₁, the function F₁ calls another function F₂, the counter 124 does not continue to count a number of hardware resources consumed by the function F₂ during execution of the function F₂. For example, when the processor 160A determines that the beginning 110₂ of the function F₂ is reached during execution of the function F₁, the counter 124 stops its count. After the execution of the function F₂, the count of counter 124 continues its count from where it left off before execution of the function F₂ if the function F₁ includes more computer code that consumes hardware resources. For example, when the processor 160A determines that the end 112₂ of the function F₂ is reached and a number of hardware resource cycles are consumed during continued execution of the function F₁, the counter 124 continues its count until the function F₁ ends. Accordingly, the exclusive number CPHR₁ₑ of hardware resource cycles is counted by counter 124 during execution of the function F₁.

Similarly, exclusive numbers CPHR₂ₑ thru CPHR_{Ne} of hardware resource cycles are generated. The processor 160A stores the exclusive numbers CPHR₁ₑ thru CPHR_{Ne} of hardware resource cycles within a database 220 of the memory device 204A.

In various embodiments, the functions performed by the counters 120, 122, and 124, and the timer 114 are performed by the processor 160A. For example, the counters 120, 122, 124, and the timer 114 are integrated within the processor 160A. In some embodiments, the functions performed by the counters 120, 122, and 124, and the timer 114 are performed under the control of the processor 160A. For example, the processor 160A triggers the counter 120 to increment a count in response to determining that the function F₁ is called. As another example, the processor 160A starts the timer 114 in response to determining that the beginning 110₁ of the function F₁ is reached and stops the timer 114 in response to determining that the end 112₁ of the function F₁ is reached.

It should further be noted that the databases 216, 220, 222, and 224 are generated by executing the functions F₁ thru F_{N} while executing the modified compiler 172.

FIG. 5B is a block diagram of another embodiment of the user device 204A. A timer 115 counts inclusive time periods of execution of the functions F₁ thru F_{N} during compilation of the source code 102. For example, the timer 115 starts at a start time t_{S1i} when the processor 160A determines that the beginning 110₁ of the function F₁ is reached for execution. When the processor 160A determines that the end 112₁ of the function F₁ is reached, the timer 114 stops at a time t_{E1i}.

If the function F₁ is calling function that calls another function, the timer 114 does not stop at the time t_{S1CS1e} when the called function is called. For example, the timer 114 does not stop and continues to count at the time t_{S1CS1e} when a beginning of the called function is reached. The timer 114 stops at a time t_{E1i} when the function F₁ ends executing. A time period t_{P1i} between the times t_{S1i} and t_{E1i} is an inclusive amount of time for execution of the function F₁ by the processor 160A during compilation of the source code 102 with the modified compiler 172.

Similarly, the time periods t_{P2i} thru t_{PNi}, which are inclusive amounts of times for execution of the remaining functions F₂ thru F_{N} are determined based on the remaining start times t_{S2i} thru t_{SNi} and the remaining end times t_{E2i} thru t_{ENi}. The processor creates a database 217 of the start times t_{S1i} thru t_{SNi}, the end times t_{P1i} thru t_{ENi}, and the time periods t_{P1i} thru t_{PNi} for the functions F₁ thru F_{N}.

A counter 121 increments its count when the function F₂ is called by the same function F₂ or another function F₁ or F₃ thru F_{N} during compilation of the source code 102. For example, when the function F₂ is called by the function F₃, the beginning 110₂ of the function F₂ is determined by the processor 160A, the function F₂ is executed, and the counter 121 increments its count.

If the function F₂ is a calling function that includes a call to another function F₃, the counter 121 increments when the function F₃ is called to generate an inclusive number of times FCC₂ᵢ the function F₂ is called. For example, when the processor 160A determines that the beginning 110₃ of the function F₃ is reached during execution of the function F₂, the counter 120 increments its count. In this example, the count FCC₂ᵢ is equal to two, one for calling the function F₂ and another one for calling the function F₃ during execution of the function F₂. If after execution of the function F₃, the function F₂ continues execution, the counter 120 does not increment its count. The count FCC₂ᵢ of a number of inclusive times the function F₂ is called is an inclusive count.

Similarly, inclusive counts FCC₁ᵢ and FCC₃ᵢ thru FCC_{Ni} corresponding to functions F₁ and F₃ thru F_{N} are determined. The exclusive counts FCC₁ᵢ thru FCC_{Ni} are stored in a database 225 of the memory device 204A.

A counter 123 counts a number of hardware resource cycles consumed by execution of each function F₁ thru F_{N} during compilation of the source code 102. For example, each time a processor cycle of processor 160A passes during execution of the function F₁, the counter 123 increments. As another example, when the processor 160A determines that the beginning 110₁ of the function F₁ is reached, the counter 123 starts counting a number of memory cycles of one or more memory elements used during execution of the function F₁.

If the function F₁ is a calling function that calls another function F₂, the counter 123 continues to increment during execution of the function F₂ to generate an inclusive number CPHRC₁ᵢ of hardware resource cycles. For example, if during execution of the function F₁, the processor 160A determines that the beginning 110₂ of the function F₂ is reached, the counter 123 continues its count to determine a cumulative number of hardware resource cycles consumed by execution of the functions F₁ and F₂. After the execution of the function F₂, counter 123 also continues its count. For example, when the processor 160A determines that the end 112₂ of the function F₂ is reached, the counter 123 continues its count of any hardware resource cycles consumed by the remaining code of the function F₁. When an end of the function F₁ is reached after execution of the function F₂, the counter 123 stops counting a number of hardware resource cycles. For example, when the processor 160A determines that the end 112₁ is reached, the counter 123 stops its count. Accordingly, the inclusive number of hardware resource cycles CPHRC₁ᵢ is counted by counter 123 during execution of the function F₁. The inclusive number of hardware resource cycles CPHRC₁ᵢ of the calling function F₁ includes a total number of hardware resource cycles consumed by the calling function F₁ and the called function F₂.

Similarly, an inclusive number CPHRC₂ᵢ thru CPHRC_{Ni} of hardware resource cycles are generated. The processor 160A stores the inclusive numbers CPHRC₁ᵢ thru CPHRC_{Ni} of hardware resource cycles within a database 223 of the memory device 204A.

Another counter 125 counts a number of hardware resources consumed by execution of each function F₁ thru F_{N} during compilation of the source code 102 to generate inclusive numbers CPHR₁ᵢ thru CPHR_{Ni} of hardware resources used during execution of the functions F₁ thru F_{N}. For example, each time a memory element, such as a memory cell or a memory device, is accessed, for an operation, such as a read or a write, during execution of the function F₁, the counter 125 increments. As another example, when the processor 160A determines that the beginning 110₁ of the function F₁ is reached and each time a memory element is used during execution of the function F₁, the counter 125 increments.

If during execution of the function F₁, the function F₁ calls another function F₂, the counter 125 continues to count a number of hardware resources consumed by the function F₂ during execution of the function F₂. For example, when the processor 160A determines that the beginning 110₂ of the function F₂ is reached during execution of the function F₁, the counter 125 continues it count to determine a number of hardware resources consumed by compilation of the function F₂. After the execution of the function F₂, the counter 125 also continues its count if the function F₁ includes more computer code that consumes hardware resources. For example, when the processor 160A determines that the end 112₂ of the function F₂ is reached and a number of hardware resource cycles are consumed during continued execution of the function F₁, the counter 125 continues its count from the count at the end of execution of the function F₂. Accordingly, the inclusive number CPHR₁ᵢ of hardware resource cycles is counted by counter 125 during execution of the function F₁.

Similarly, inclusive numbers CPHR₂ᵢ thru CPHR_{Ni} of hardware resource cycles are generated. The processor 160A stores the inclusive numbers CPHR₁ᵢ thru CPHR_{Ni} of hardware resource cycles within a database 221 of the memory device 204A.

In various embodiments, the functions performed by the counters 121, 123, and 125, and the timer 115 are performed by the processor 160A. For example, the counters 121, 123, and 125, and the timer 115 are integrated within the processor 160A. In some embodiments, the functions performed by the counters 121, 123, and 125, and the timer 115 are performed under the control of the processor 160A. For example, the processor 160A triggers the counter 121 to increment a count in response to determining that the function F₁ is called. As another example, the processor 160A starts the timer 115 in response to determining that the beginning 110₁ of the function F₁ is reached and stops the timer 115 in response to determining that the end 112₁ of the function F₁ is reached.

It should be noted that when a function does not call another function, an inclusive metric of the function is equal to its exclusive metric. For example, if the function F₂ does not call the function F_{N}, an exclusive amount of time taken to execute the function F₂ during compilation of the source code 102 is equal to an inclusive amount of time taken to execute the function F₂.

It should further be noted that the databases 217, 221, 223, and 225 are generated by executing the functions F₁ thru F_{N} while executing the modified compiler 172.

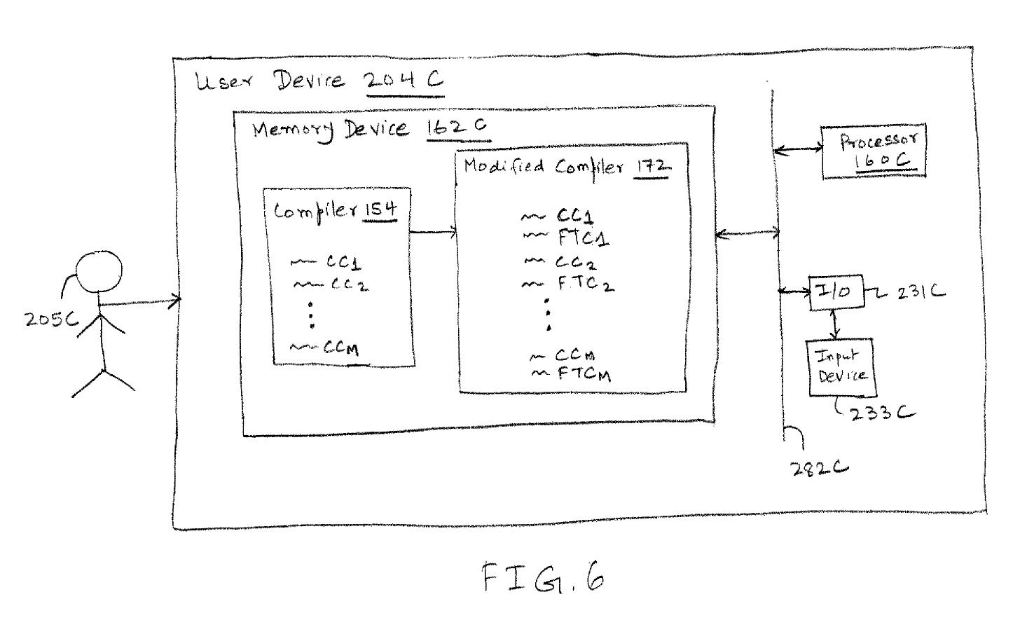

FIG. 6 is a block diagram of an embodiment of a user device 204C that is used to generate the modified compiler 172. The processor 160C of the user device 204C accesses an unmodified compiler 154 from a memory device 162C of the user device 204C. The compiler 154 includes codes CC₁, CC₂ thru CC_{M}, where M is an integer greater than zero. Each code CC₁, CC₁, thru CC_{M} includes one or more lines of code. The processor 160C inserts a function tracking command in the unmodified compiler 154 to instrument the unmodified compiler 154. A function tracking command is sometimes referred to herein as a modification code. As an example, the function tracking command FTC₁ is inserted between the compiler code CC₁ and the compiler code CC₂ in the compiler 154 to determine a beginning of each of the functions F₁ thru F_{N} and the function tracking command FTC₂ in inserted in the compiler 154 to determining an ending of each of the functions. As another example, the function tracking command FTC₃ is inserted in the compiler 154 to start the timer 114 or 115 (FIGS. 5A and 5B) at a beginning of each of the functions F₁ thru F_{N} and the function tracking command FTC₄ is inserted in the compiler 154 to stop the timer at an end of each of the functions F₁ thru F_{N}.

Similarly, the processor 160C inserts various function tracking commands FTC₅ thru FTC_{M} to instrument the compiler 154. As an example, the function tracking command FTC₅ is inserted in the compiler 154 to increment a count of counter 120 or 121 (FIGS. 5A and 5B) at a beginning of execution each of the functions F₁ thru F_{N}. In this example, each time one of the functions F₁ thru F_{N} is called to be executed, the count increments. As yet another example, the function tracking command FTC₆ is inserted in the compiler 154 to increment a count of the counter 124 or 125 (FIGS. 5A and 5B) each time a hardware resource of a user device is used to execution of one of the functions F₁ thru F_{N} within the user device and the function tracking command FTC₇ is inserted into the compiler 154 to end the count at an end of the function. As another example, the function tracking command FTC₈ is inserted in the compiler 154 to increment a count of counter 122 or 123 (FIGS. 5A and 5B) per hardware resource cycle used during execution of each of the functions F₁ thru F_{N} and the function tracking command FTC₉ is inserted in the compiler to stop the count at the end of the function.

The unmodified compiler 154 is instrumented to generate metrics for all functions within the source code 102. Each function tracking command FTC₁ thru FTC_{M} includes one or more lines of the modification code.

In some embodiments, the processor 160C inserts the function tracking command FTC₁ within or before the compiler code CC₁. In various embodiments, the processor 160 determines whether an input is received from a user 205C via an input device 233C indicating to modify the compiler 154. The input device is coupled with a bus 282C via an I/O device 231C. Upon determining that the input is received, the processor 160C modifies the compiler 154 to generate the modified compiler 172.

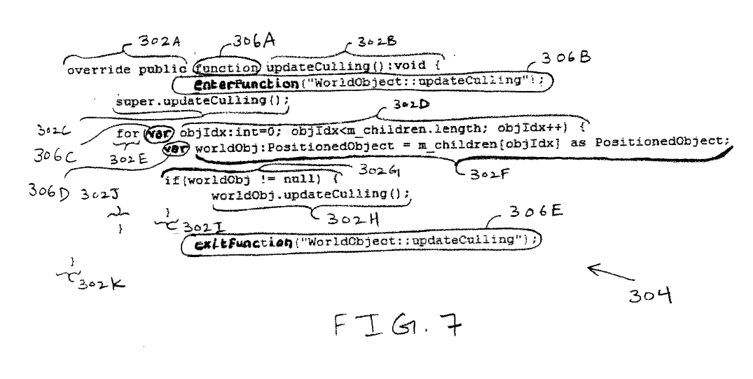

FIG. 7 is a diagram illustrating how a source code having portions 302 is treated by the modified compiler 172. The source code having the portions 302 is an example of the source code 102. When the modified compiler 172 receives the source code having portions 302, the modified compiler 172 does not compile the source code as having only the portions 302. Rather, the modified compiler 172 compiles the source code having portions 302 as another source code 304. The source code 304 includes the portions 302 and further includes portions 306.

The portions 306 include the portion 306B, which indicates that the modified compiler 172 that a function “updateculling” is beginning. The modified compiler 172 parses the character sequence “updateculling( )” and the bracket “{” in the portion 302B to determine that the “updateculling” function is beginning.

Moreover, the portions 306 include the portion 306E, which indicates that the modified compiler 172 that the function “updateculling” is ending. The modified compiler 172 parses the character sequence “updateculling( )” in the portion 302B and the bracket “}” in the portion 302J to determine that the “updateculling” function is ending.

Also, the portions 306 include the portion 306A, which indicates that the modified compiler 172 that the character sequence “updateculling” is a function. The modified compiler 172 parses the character sequence “updateculling( )” in the portion 302B to determine that the character sequence “updateculling” is a function.

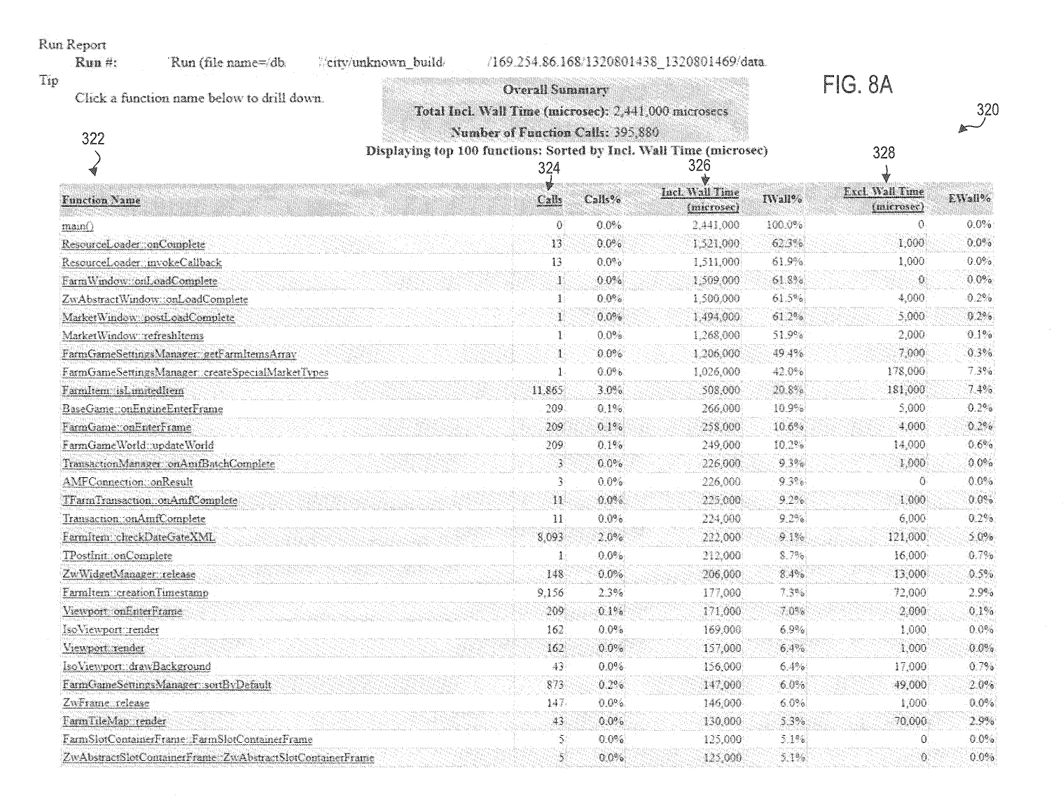

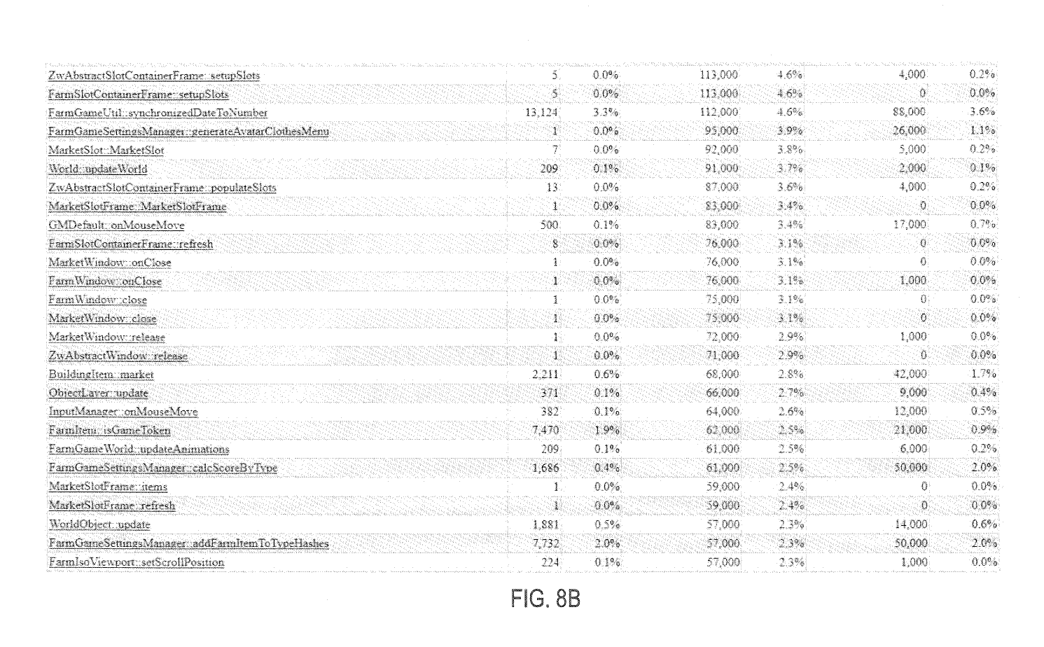

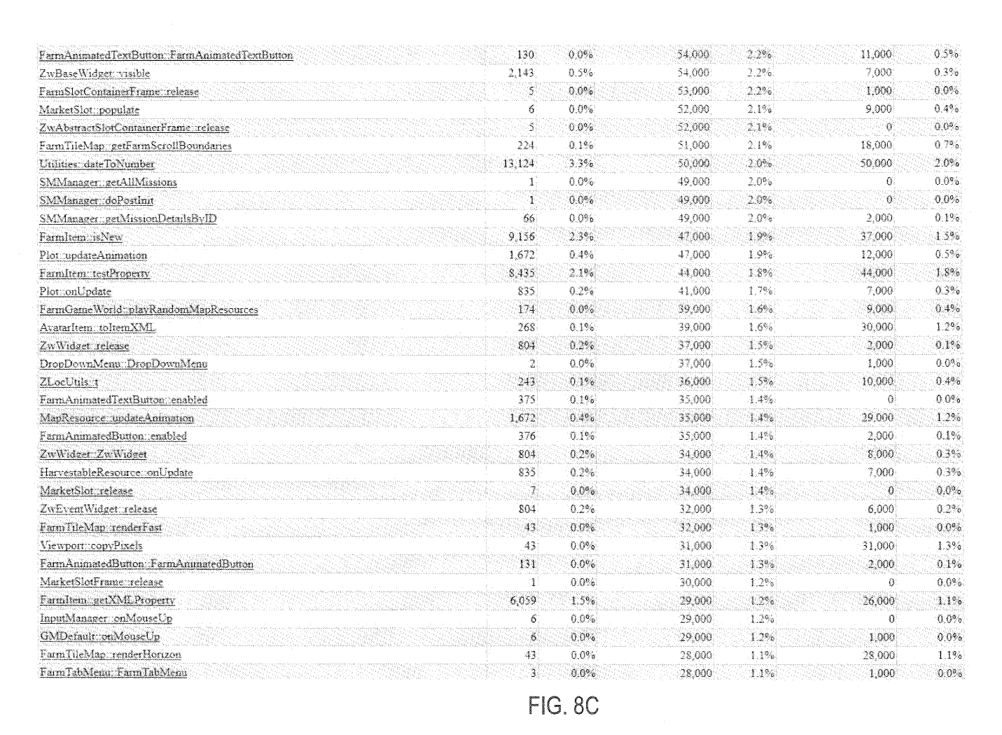

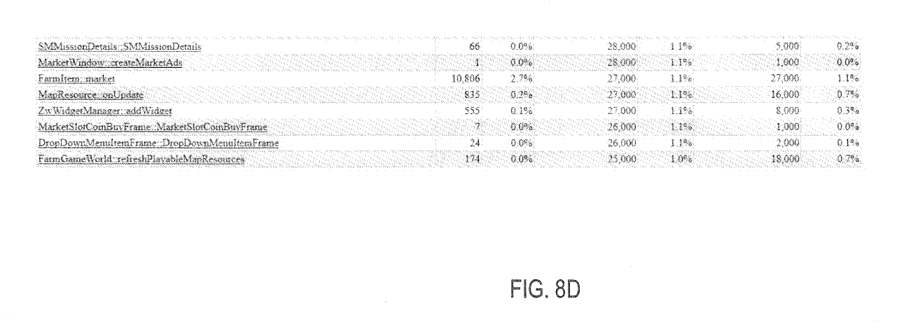

FIG. 8A is a diagram of a first portion of a report 320, which is an example of the report 140 (FIG. 1). FIG. 8B is a diagram of a second portion of the report 320, FIG. 8C is a diagram of a third portion of the report 320, and FIG. 8D is a diagram of a fourth portion of the report 320. The second portion of the report 320 follows the first portion of the report 320, the third portion of the report 320 follows the second portion of the report 320, and the fourth portion of the report 320 follows the third portion of the report 320.

A column 322 of the report 320 includes a name of 100 functions of a source code (not shown). For example, “main( )”, “ResourceLoader::onComplete” are names of functions. The remaining pages of the report 320 that include names of the remaining functions of the source code (not shown) are not shown for brevity.

Moreover, another column 324 of the report 320 includes an exclusive number times each function listed in the column 322 is called during compilation of the source code (not shown) with the modified compiler 172 (FIG. 1). For example, an exclusive number of times the function “main( )” is called is zero. As another example, an exclusive number of times the “ResourceLoader::onComplete” function is called is 13 times.

Yet another column 326 of the report 326 includes an inclusive time period of execution of each function in the column 322 during compilation of the source code (not shown) with the modified compiler 172. For example, the “main( )” function is executed for 2.441 seconds. As another example, the “ResourceLoader::onComplete” function is executed for 1.521 seconds.

Also, another column 328 of the report 320 includes an exclusive time period of execution of each function in the column 322 during compilation of the source code (not shown) with the modified compiler 172. For example, the “main( )” function is executed for 0 seconds. As another example, the “ResourceLoader::onComplete” function is executed for 1000 microseconds. It should be noted that in this embodiment, the “main( )” function does not include any code per se and there is no time taken to execute the “main( )” function during compilation of the source code (not shown) with the modified compiler 172. The “main( )” function includes the remaining functions of the source code (not shown) and has an inclusive time of execution of 2.441 seconds, as illustrated in the report.

A column titled “Calls %” includes a percentage of exclusive number of calls to a function listed in the column 322 with respect to exclusive number of calls to all functions of the source code (not shown). For example, a function named “FarmItem::market” is called exclusively for 2.7 times when all the functions of the source code (not shown) are called exclusively for 100 times. A user may decide that the function “FarmItem::market” is called for too many times compared to the remaining functions of the source code (not shown) and may decide to change a number of calls to the function to reduce hardware resources and/or hardware resource cycles consumed by the function.

In some embodiments, the report 320 also includes hyperlinks between functions. For example, when the user 205A selects the “ResourceLoader::onComplete” function via the input device 233A (FIG. 1) and if the “ResourceLoader::onComplete” function calls another function, the GPU 230A displays the other function as being a branch of the “ResourceLoader::onComplete” function.

In various embodiments, a module, as used herein, is a computer program that is executed by a processor to perform the operations described herein as being performed by the module. However, in one embodiment, a module is implemented in hardware, such as within a PLD or an ASIC, or is implemented in firmware. For example, the modified compiler 172 may be implemented within an integrated circuit rather than being stored in memory device 206A (FIG. 1).

In one embodiment, a module, as used herein, is embodied as computer-readable code on a computer-readable medium. The computer-readable medium is any data storage device that can store data, which can be thereafter be read by a computer. Examples of the computer-readable medium include hard drives, network attached storage (NAS), ROM, RAM, a memory device, compact disc-ROMs (CD-ROMs), CD-recordables (CD-Rs), CD-rewritables (RWs), magnetic tapes and other optical and non-optical data storage devices. The computer-readable medium can include a non-transitory computer-readable tangible medium distributed over a network-coupled computer system so that the computer readable code is stored and executed in a distributed fashion.

It should be noted that various embodiments of the present invention may be practiced with various computer system configurations including hand-held devices, microprocessor systems, microprocessor-based or programmable consumer electronics, minicomputers, mainframe computers and the like. Some embodiments of the present invention can also be practiced in distributed computing environments where tasks are performed by remote processing devices that are linked through a wire-based or wireless network.

With the above embodiments in mind, it should be understood that the embodiments can employ various computer-implemented operations involving data stored in computer systems. These operations are those requiring physical manipulation of physical quantities. Any of the operations described herein that form part of the embodiments of the present invention are useful machine operations. Various embodiments of the present invention also relate to a device or an apparatus for performing these operations. The apparatus can be specially constructed for a specific purpose. The apparatus is selectively activated or configured by a computer program stored in the computer.

Although some operations are described in a specific order, it should be understood that other housekeeping operations may be performed in between operations, or operations may be adjusted so that they occur at slightly different times or in a different order than that described, or may be distributed in a system which allows the occurrence of the operations at various intervals, as long as the operations are performed in the desired way. For example, in some embodiments, the operation 104 (FIG. 2) is performed after the operation 106.

Although various embodiments of the present invention have been described in some detail for purposes of clarity of understanding, certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method for generating a profile of a source code, the method comprising:
receiving the source code, the source code excluding instrumentation and including functions; and
compiling the source code with the compiler to generate metrics that are associated with execution of the functions within the source code, wherein compiling the source code includes applying function tracking commands that were inserted into a compiler, the commands for tracking beginnings and ends of the functions to be tested.

2. The method of claim 1, wherein receiving the source code comprises receiving a game code.

3. The method of claim 1, wherein receiving the source code comprises receiving an object-oriented code.

4. The method of claim 1, wherein receiving the source code comprises receiving an ActionScript code.

5. The method of claim 1, wherein the instrumentation includes a modification of the source code.

6. The method of claim 1, wherein compiling the source code comprises:
parsing the source code to determine the beginnings and ends of the functions;
initiating a timer in response to determining the beginning of each of the functions; and
stopping the timer in response to determining the end of each of the functions.

7. The method of claim 1, wherein compiling the source code comprises:
parsing the source code to determine a beginning of each of the functions; and
incrementing a count at the beginning of execution of each of the functions.

8. The method of claim 1, wherein compiling the source code comprises:
parsing the source code to determine a beginning or an end of each of the functions; and
incrementing a count per hardware resource used during execution of each of the functions, the execution occurring after the beginning of each of the functions.

9. The method of claim 1, wherein compiling the source code comprises:
parsing the source code to determine a beginning or an end of each of the functions;
incrementing a count per hardware resource cycle used during execution of each of the functions, the execution occurring after the beginning of each of the functions; and
stopping the count at the end of each of the functions.

10. The method of claim 1, wherein compiling the source code comprises:
parsing the source code to determine a beginning or an end of each of the functions;
determining when the function is called by the same or another function in response to determining the beginning of each of the functions; and
incrementing a count in response to determining that the function is called by the same or the different function.

11. A method for generating a profile of a source code, the method comprising:
receiving profile data including metrics, the metrics associated with execution of functions within the source code, the source code excluding instrumentation, the source code compiled using a compiler to generate the metrics, the compiler including function tracking commands, the commands used to track beginnings and ends of the functions;
generating report data from the profile data;
rendering a report based on the report data; and
sending the report data via a computer network.

12. The method of claim 11, wherein receiving the profile data comprises receiving the profile data via the computer network, wherein generating the report data from the profile data comprises generating associations between one of the functions and one of the remaining of the functions, wherein sending the report data via the computer network comprises sending the report data to a user device via the Internet.

13. A method for modifying a compiler to generate a profile of a source code, the method comprising:
receiving the compiler; and
modifying the compiler to generate metrics that are associated with execution of functions within the source code, wherein said modifying the compiler includes inserting function tracking commands, the commands used to track beginnings and ends of the functions, the source code excluding instrumentation, wherein the method is performed by a processor.

14. The method of claim 13, wherein receiving the compiler comprises accessing the compiler from a memory device.

15. The method of claim 13, wherein modifying the compiler comprises instrumenting the compiler to generate the metrics for all functions within the source code.

16. The method of claim 13, wherein modifying the compiler comprises:
inserting a modification code in the compiler to start a timer at a beginning of each of the functions;
inserting a modification code in the compiler to stop the timer at an end of each of the functions.

17. The method of claim 13, wherein modifying the compiler comprises inserting a modification code in the compiler to increment a count at a beginning of each of the functions.

18. The method of claim 13, wherein modifying the compiler comprises:
inserting a modification code in the compiler to increment a count per hardware resource used during execution of each of the functions, the execution occurring after a beginning of each of the functions; and
inserting a modification code in the compiler to stop the count at the end of each of the functions.

19. The method of claim 13, wherein modifying the compiler comprises:
inserting a modification code in the compiler to increment a count per hardware resource cycle used during execution of each of the functions, the execution occurring after the beginning of each of the functions; and
inserting a modification code in the compiler to stop the count at the end of each of the functions.

20. The method of claim 13, wherein modifying the compiler comprises:
inserting a modification code in the compiler to determine whether each of the functions is called by the same or another function; and
inserting a modification code in the compiler to increment a count in response to determining that the function is called by the same or the different function.
